(19) United States
(12) Patent Application Publication
(10) Pub. No.: US 2012/0279210 A1
(43) Pub. Date: Nov. 8, 2012

(54) TRANSMISSION OF A MOTOR VEHICLE, HAVING AN INPUT SHAFT AND AN OUTPUT SHAFT

(76) Inventor: Steffen STRAUSS, Gerlingen (DE)

(21) Appl. No.: 13/458,778

(22) Filed: Apr. 27, 2012

(30) Foreign Application Priority Data
May 6, 2011 (DE) 10 2011 075 411.3

(51) Int. Cl. F16D 31/00

(52) U.S. Cl. 60/445; 60/486

(57) ABSTRACT

A transmission of a motor vehicle includes: an input shaft and an output shaft; at least one hydraulically operable actuator, hydraulic lubrication and/or oil cooling; a first hydraulic pump which is driven directly or indirectly by the input shaft; and a second hydraulic pump which is driven directly or indirectly by the output shaft.

### BACKGROUND OF THE INVENTION

1. Field of the Invention

The present invention relates to an automatic transmission for a motor vehicle and a method for controlling such a motor vehicle transmission.

2. Brief Description of the Invention

Various automatic transmissions of motor vehicles are known, such as automatic transmissions (stepped automatic transmissions), dual-clutch transmissions (DCT), continuously variable transmissions (CVT) or semi-automatic mechanical transmissions, which are operable with the aid of hydraulic actuators. The hydraulic energy necessary for operation is provided, for example, by a hydraulic pump driven electrically or mechanically by the internal combustion engine. In addition, the hydraulic pump may also be used for, charging a hydraulic accumulator, which, for instance, in the case of start/stop operation of the motor vehicle, temporarily allows oil pressure to be supplied independently of the internal combustion engine.

As a rule, the above-mentioned automatic transmissions are hydraulically operated and require a corresponding hydraulic pressure or volumetric flow rate. In the case of using a mechanically driven hydraulic pump, because of the speed-proportional dependence of the volumetric flow rate and the requirement that a sufficient amount of fluid even be delivered at idling speed and the highest oil temperature, the hydraulic pump is overdimensioned as a rule. An excess quantity of the hydraulic oil is directed back into a tank.

Published patent and patent application documents from this area include, for example, Japanese patent application document JP-2007138993 A; German patent application documents DE 10 2006 041 899 A1, DE 10 2006 014 756 A1 and DE 10 2006 014 758 A1; Japanese patent application document JP-10250402 A; U.S. Pat. No. 5,293,789; European Patent EP 1265009 B1; US Patent Application Publication 20050096171 A1; and European patent application document EP 1353075 A2.

### BRIEF SUMMARY OF THE INVENTION

The transmission of the present invention has the advantage that it may also be supplied with hydraulic oil during the so-called coasting operation and/or a start/stop operation. In particular, it is not necessary to use an electric hydraulic pump for operating a hydraulic system of an automatic transmission (AT) or a continuously variable transmission (CVT). In this manner, it is possible to switch off the internal combustion engine of the motor vehicle during coasting operation and thereby markedly reduce the fuel consumption. The rolling of the motor vehicle, during which the internal combustion engine is decoupled from the rolling wheels and the internal combustion engine is shut off, is referred to as “coasting operation.”

When the combustion engine is switched on again, the hydraulic pressure in the hydraulic system may be built up particularly rapidly, and consequently, the continued travel and/or the starting from rest of the motor vehicle may be assisted in an optimum manner. In addition, the combination of two hydraulic pumps according to the present invention is comparatively inexpensive, since only two relatively small hydraulic pumps are needed.

The present invention is based on the consideration that in coasting operation, it is particularly advantageous for the combustion engine of the motor vehicle to be temporarily shut off. In this case, no fuel is consumed during coasting operation. In contrast to a stopping phase of the combustion engine in the so-called start/stop operation, the transmission continues to be operated during coasting operation. In many transmission designs, it is also necessary, during coasting operation, to supply the transmission with hydraulic oil, to hold clutches of the transmission in a predetermined position and/or to cool the hydraulic oil or the transmission.

The clutches of the transmission are mostly driven by hydraulically operable actuators. According to the present invention, the transmission of the present invention has two hydraulic pumps for the driving of these clutches, as well as for the above-mentioned hydraulic lubrication and/or hydraulic cooling (“oil cooling”). A first hydraulic pump is driven directly or indirectly by an input shaft of the transmission, so that it is always running when the combustion engine is running.

However, the combustion engine is stopped during the coasting operation of the motor vehicle, which means that the input shaft of the transmission is no longer being driven. In this case, the first hydraulic pump is not able to deliver any more hydraulic oil. The second hydraulic pump of the present invention is driven directly or indirectly by an output shaft of the transmission, so that it may take over the supplying of oil to the transmission during coasting operation.

The first and the second hydraulic pumps are preferably mechanically driven. In this context, in normal operation of the motor vehicle, the first hydraulic pump may assume a greater proportion of the delivery of the hydraulic oil than the second hydraulic pump. In a neutral position or a park position of the transmission, the first hydraulic pump may assume the entire share of the delivery of the hydraulic oil, since in these operational cases, the output shaft does not rotate and, consequently, the second hydraulic pump does not pump.

In accordance with the present invention, “direct” drive of the hydraulic pump is provided when the hydraulic pump is positioned on the input shaft of the transmission. “Indirect” drive is presently understood to mean that the hydraulic pump is coupled to the input shaft via a transmission device. The transmission device is, for example, a gear, a chain or a drive belt. The same applies to the second hydraulic pump, which is positioned at the output shaft.

In particular, the transmission device in the case of the first hydraulic pump may also be a torque converter of a stepped automatic transmission (AT). In the case of direct or indirect drive of the hydraulic pumps, their speed is a function of the speed of the input shaft or the output shaft.

The first hydraulic pump and the second hydraulic pump belong to the same hydraulic system of the transmission. They preferably operate in such a manner, that the hydraulic streams delivered by the first hydraulic pump and the second hydraulic pump are merged and added. During coasting operation, the first hydraulic pump cannot provide any feeding capacity when the input shaft is stationary. In this case, the second hydraulic pump renders possible the supply of hydraulic oil to the transmission that is necessary for coasting operation.

According to the present invention, it is provided that the transmission is a stepped automatic transmission, a continuously variable transmission, a dual-clutch transmission, or an automated manual transmission. A stepped automatic transmission (AT) is an automatic transmission of a motor vehicle, which provides the required transmission between the internal combustion engine and the wheels in stepped gear ratios. In general, a stepped automatic transmission has several valves, clutches and/or brakes, which are operated hydraulically, for example. In the context of coasting operation, the lubrication of the transmission and the attainment of a short restarting time require special consideration.

A continuously variable transmission (CVT) allows the gear ratio between the internal combustion engine and the wheels to be adjusted almost steplessly in a predetermined range. For example, such a transmission includes a push belt, which is positioned between two pairs of V-pulley halves (PU). A spacing of the V-pulley halves determines a radius, at which the push belt is frictionally coupled to the respective V-pulley. In the context of coasting operation, the lubrication of the transmission, the pressing of the V-pulley halves and the attainment of a short restarting time require special consideration.

A so-called dual-clutch transmission (DCT) generally includes two partial transmissions, which allow a change of gear without interrupting the traction force. In this context, the changing of gears may also be performed fully automatically. In the context of coasting operation, the lubrication and cooling of the transmission, the holding-open of the two clutches and the attainment of a short restarting time require special consideration.

In the case of the so-called automated manual transmission (AMT), the changing of gears and the operation of the clutch is performed with the aid of hydraulic or eldctric actuators. The second hydraulic pump of the present invention allows the above-described transmission variants to also be operated in a precise manner during coasting operation, that is, to be lubricated and/or cooled, as well as a clutch to be held open and hydraulically operated actuators to be activated.

One embodiment of the present invention provides that the first hydraulic pump be driven via a part of a torque converter coupled to the input shaft. Thus, the first hydraulic pump is coupled to the internal combustion engine of the vehicle. If the internal combustion engine is running, then the first hydraulic pump is able to pump. This set-up of the hydraulic pump is particularly simple to operate.

In addition, it is provided that the delivery capacity of the first and/or the second hydraulic pump is controllable. For example, the first and/or the second hydraulic pump may be mechanically regulated and designed as a sliding-vane discharge pump. In this context, an eccentricity may be adjusted, through which the feeding capacity provided by the pump is changed. In this manner, the quantity of hydraulic oil necessary for the transmission may be optimally adjusted to a specific operating state. This relates to the normal vehicle operation, the stopping operation and/or the coasting operation of the vehicle.

One embodiment of the present invention provides that the delivery capacity of the first hydraulic pump be controllable, and that the delivery capacity of the second hydraulic pump not be controllable. The delivery capacity of the second hydraulic pump may be engineered, for example, to suitable operating points and/or speeds of the vehicle or the internal combustion engine. The combination of a regulated, first hydraulic pump with an unregulated, second hydraulic pump is particularly advantageous, since the volumetric flow rate of the second hydraulic pump is approximately proportional to the speed of the vehicle, while the volumetric flow rate of the first hydraulic pump is approximately proportional to the speed of the internal combustion engine.

The power demand of the hydraulic system may be minimized at almost all operating points, by suitably sizing the two hydraulic pumps and suitably controlling the first hydraulic pump. In addition, a non-controllable, second hydraulic pump may be manufactured inexpensively.

A further embodiment of the present invention provides that a feed pressure of the second hydraulic pump be less than a feed pressure of the first hydraulic pump. In this manner, the operation of the second hydraulic pump may be advantageously adapted to the start/stop operation or the coasting operation of the vehicle. In the case of stepped automatic transmissions (AT), in particular, the second hydraulic pump may be optimized with respect to the “lubricating” function, for which, in general, a comparatively low pressure is necessary. In the case of the continuously variable transmission (CVT), the hydraulic pressure may be greater in the stopping operation or in the coasting operation, in order to additionally generate the required contact pressure or adjusting pressure for the pairs of V-pulley halves (“pulleys”).

In addition, it is provided that a delivery capacity of the second hydraulic pump is less than a delivery capacity of the first hydraulic pump at the same speed. In this manner, it is taken into consideration that the volumetric flow rate to be delivered is generally lower during stopping operation or coasting operation of the vehicle. In particular, the second hydraulic pump may be preferably engineered for suitable operating points or speeds. In this manner, the power loss of the second hydraulic pump may be reduced, and consequently, fuel may be conserved.

A further embodiment of the present invention provides that a check valve, which prevents the hydraulic oil from flowing back in a direction opposite to the delivery direction of the hydraulic pumps, be provided on a delivery side of the first and/or the second hydraulic pump. In this manner, the first and the second hydraulic pumps may be hydraulically interconnected on their delivery sides in a particularly simple manner.

If the first hydraulic pump is not pumping while the internal combustion engine is stopped, this prevents the hydraulic pressure or the delivered volume generated by the second hydraulic pump from being exhausted through the first hydraulic pump. The same applies in normal vehicle operation, when the first hydraulic pump generates a higher pressure than the second hydraulic pump. In this manner, interference-free operation of the two hydraulic pumps may be achieved in a particularly simple manner.

The present invention operates more effectively, when the hydraulic system powered by the first and the second hydraulic pumps has at least one pressure sensor, which is used for controlling and/or for diagnosing the transmission. In this manner, the hydraulic system or the first and/or the second hydraulic pump may not only be controlled, but also regulated. Consequently, in all of the operating cases of the motor vehicle, a respectively optimum hydraulic pressure may be reached in the hydraulic system of the transmission. In addition, a signal generated by the pressure sensor may be used for diagnosing the transmission.

A useful embodiment of the present invention includes a hydraulic accumulator, which is hydraulically connected to the hydraulic system of the transmission. The hydraulic accumulator is preferably controlled by a transmission control system of the transmission, or by another control unit (“control and/or regulating device”) of the internal combustion engine or the motor vehicle. In this context, the time and/or the duration of the control may occur in a coordinated manner as a function of the other available parameters, such as the vehicle speed. In the case of a start-stop operation of the vehicle, a specific quantity of hydraulic oil may be introduced into the hydraulic system when driving on from a low speed or from a dead stop, in order to compensate for any leakage and to generate a minimum pressure of the hydraulic oil. Consequently, the action of the first hydraulic pump may be supported, in particular, at low speeds of the internal combustion engine. In addition to the start-stop operation, the hydraulic accumulator may support the coasting operation of the vehicle, for example, by additionally stabilizing the hydraulic pressure of the transmission during coasting operation.

Furthermore, the present invention relates to a method for supplying oil to a transmission of a motor vehicle; an actual pressure in the hydraulic system being adjusted to a first setpoint value (Psetpoint, normal operation) by a pressure control system, when the first hydraulic pump is pumping. In this manner, the pressure in the hydraulic system of the transmission may be regulated during normal vehicle operation, irrespective of the characteristics of the second hydraulic pump coupled to the transmission output shaft.

In addition, the method of the present invention provides that an actual pressure in the hydraulic system be adjusted to a second setpoint value (Psetpoint, coasting) by the pressure control system, when only the second hydraulic pump is pumping. The coasting operation of the vehicle is described by this; the second setpoint value of the hydraulic pressure in the hydraulic system of the transmission possibly being less than, or being able to be less than, in normal vehicle operation. In this manner, the second hydraulic pump may be constructed to be smaller, and costs may be reduced.

One embodiment of the method provides that the first setpoint value (Psetpoint, normal operation) be greater than the second setpoint value (Psetpoint, coasting). In this manner, it is taken into account that the hydraulic pressure during vehicle operation is generally greater than the required hydraulic pressure during coasting operation.

In addition, the method may be implemented in such a manner, that pressure is controlled by adjusting the delivery capacities of the first and/or second hydraulic pump. In this context, the first and/or the second hydraulic pump may be configured as a so-called sliding-vane discharge pump and controlled by the transmission control system. In this manner, additional actuators for controlling the hydraulic pressure, or even a system pressure regulator, may be dispensed with, which means that costs may be reduced.

Furthermore, the present invention may alternatively or additionally allow the pressure to be controlled by activating a pressure control valve. In this manner, the method of the present invention may possibly be implemented more simply and/or more precisely.

The method may be advantageously executed by a computer program, which is programmed for controlling the transmission and/or the first and/or the second hydraulic pump. The computer program preferably runs on a control and/or regulating device of the transmission (transmission control unit) or of the internal combustion engine, the computer program being stored in a memory. The computer program is configured, inter alia, to coordinate the operation of the first and the second hydraulic pumps and to optimally adapt it to a specific operating state of the motor vehicle, in particular, to the coasting operation.

### BRIEF DESCRIPTION OF THE DRAWINGS

FIG. 1 shows a schematic drawing of a motor vehicle having an internal combustion engine, a transmission according to the present invention, and a transmission control system.

FIG. 2 shows a graph for representing a coasting operation of the motor vehicle.

### DETAILED DESCRIPTION OF THE INVENTION

In all of the figures, and even in the case of different specific embodiments, the same reference characters are used for functionally equivalent elements and variables.

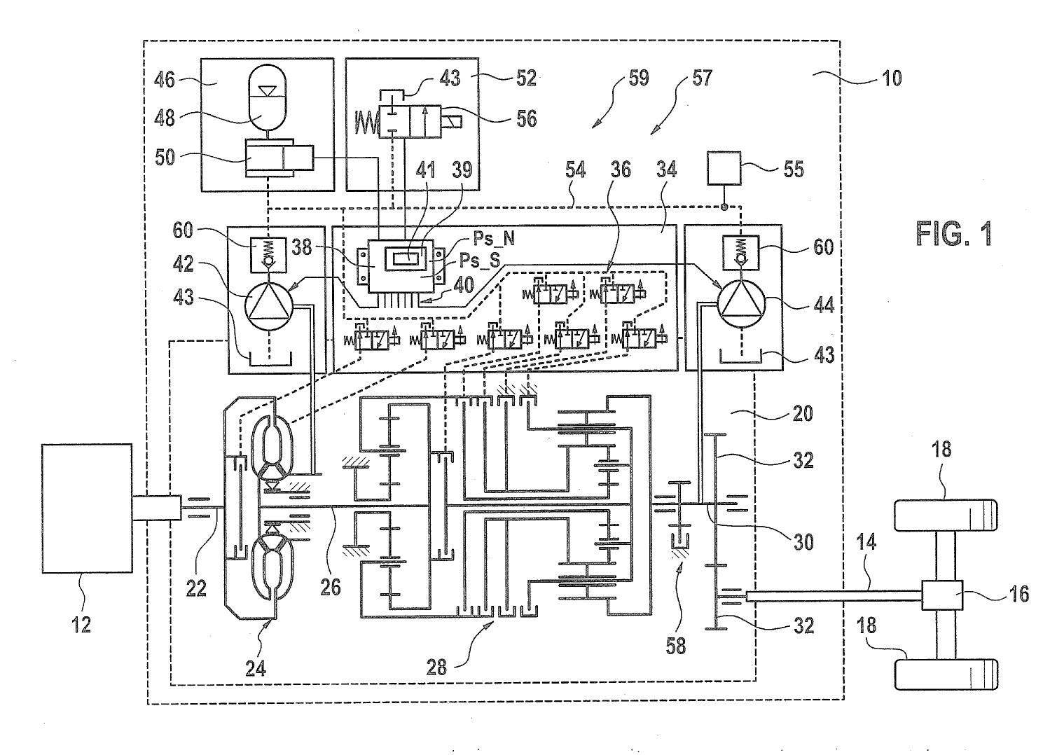

FIG. 1 shows a transmission 10 of a motor vehicle, which is illustrated in a middle region of the drawing. In the present case, transmission 10 is a stepped automatic transmission (AT). An internal combustion engine 12 is illustrated in the left region of the drawing, and the drive unit of the vehicle is illustrated in the right region of the drawing. In the present case, the drive unit includes a shaft 14, a differential 16 and two wheels 18. In the representation of FIG. 1, the transmission of force or the transmission of power essentially occurs from left to right.

Transmission mechanics 20, which presently include hydraulic components as well, are illustrated in the lower middle region of FIG. 1. In the left lower region in the drawing, transmission mechanics 20 are coupled to internal combustion engine 12 by an input shaft 22. Inside of transmission mechanics 20, input shaft 22 is coupled to a torque converter 24. A shaft 26 connects torque converter 24 to a gearing arrangement 28, which includes planetary gear sets, clutches and brakes (not denoted by reference numerals). An output shaft 30, which may act upon shaft 14 via gear wheels 32, is illustrated to the right of gearing arrangement 28 in the drawing.

In the drawing, a hydraulic transmission control system 34 is illustrated above transmission mechanics 20. Transmission control system 34 includes several hydraulic valves 36, which are hydraulically connected to torque converter 24 or gearing arrangement 28. In addition, transmission control system 34 includes a transmission control unit 38 (“control and/or regulating device”), which is illustrated in the drawing in the upper left region of transmission control system 34.

Transmission control unit 38 includes a memory 39, in which a computer program 41 is stored. Several control lines 40, which may control, inter alia, electromagnetically operable hydraulic valves 36, are indicated in the drawing, below transmission control unit 38.

In the drawing, a first hydraulic pump 42 is illustrated to the left of transmission control system 34 and above torque converter 24. A second hydraulic pump 44 is illustrated in the drawing, to the right of transmission control system 34. In the drawing, a hydraulic accumulator 46, which includes an accumulator element 48 and an actuating device 50, is situated above first hydraulic pump 42. A system pressure regulator 52 (“pressure control valve”) is illustrated to the right of hydraulic accumulator 46. System pressure regulator 52 is connected by hydraulic lines 54 to, inter alia, hydraulic accumulator 46, first hydraulic pump 42, second hydraulic pump 44 and transmission control system 34. In addition, a pressure sensor 55, which may determine the hydraulic pressure prevailing in hydraulic lines 54 and transmit it to transmission control system 34, is connected to hydraulic lines 54.

Transmission control system 34, first and second hydraulic pumps 42 and 44, hydraulic valves 36, hydraulic accumulator 46, system pressure regulator 52 and hydraulic lines 54 are part of a hydraulic system 57, which is symbolically represented by its reference numeral. A pressure control system 59 is symbolically represented by its reference numeral, as well. Pressure control system 59 includes devices that are suitable for controlling or regulating the pressure in hydraulic system 57, in particular, system pressure regulator 52 and/or those parts of transmission control unit 38, with the aid of which first and second hydraulic pumps 42 and 44 may be controlled and/or their power output may be changed. In particular, pressure control system 59 uses setpoint values Ps_N and Ps_S for regulating an actual pressure in hydraulic system 57 in accordance with a specific operating case of internal combustion engine 12 or of the motor vehicle, as will be explained further below. In this context, first setpoint value Ps_N is presently greater than second setpoint value Ps_S.

Actuating device 50 of hydraulic accumulator 46, as well as a valve device 56 of system pressure regulator 52, are electrically connected to transmission control unit 38. First hydraulic pump 42 is driven via a part of the torque converter 24 coupled to input shaft 22. Second hydraulic pump 44 is driven by output shaft 30. In the drawing, output shaft 30 is coupled to a parking lock 58 to the right of gearing arrangement 28.

In normal operation of the motor vehicle, internal combustion engine 12 drives torque converter 24 via input shaft 22. Torque converter 24 transmits mechanical power to gearing arrangement 28 with the aid of shaft 26. Via output shaft 30, gearing arrangement 28 acts upon gear wheels 32, through which shaft 14, differential 16 and, finally, wheels 18 are driven. In this context, torque converter 24 is controlled by transmission control system 34 with the aid of hydraulic valves 36. In the same manner, gearing arrangement 28, that is, the planetary gear sets, clutches and brakes contained in gearing arrangement 28, is controlled with the aid of hydraulic valves 36. First hydraulic pump 42 is configured as a sliding-vane discharge pump and is controlled by transmission control unit 38. In the present case, second hydraulic pump 44 is not controlled.

First hydraulic pump 42 and second hydraulic pump 44 feed hydraulic oil from a reservoir 43 into hydraulic lines 54, and to the devices connected to hydraulic lines 54. In this context, during normal operation of the vehicle, when first hydraulic pump 42 is pumping, an actual pressure in hydraulic system 57 is adjusted to setpoint value Ps_N (Psetpoint, normal operation) by transmission control unit 38 and system pressure regulator 52.

In normal vehicle operation, given the same rotational speed, a feed pressure or a delivery capacity of second hydraulic pump 44 is presently less than a feed pressure or a delivery capacity of first hydraulic pump 42. Using a check valve 60 assigned to hydraulic pump 44, it is ensured that no hydraulic oil may flow from hydraulic lines 54 back into reservoir 43, counter to the normal delivery direction of second hydraulic pump 44.

During coasting operation of the vehicle, the transmission of force, i.e., the power transmission, between input shaft 22 and output shaft 30 is interrupted. In this context, internal combustion engine 12 is temporarily switched off. However, wheels 18, as well as differential 16, shaft 14 and output shaft 30, continue to be driven by the rolling vehicle. Consequently, second hydraulic pump 44 may continue to pump hydraulic oil into hydraulic lines 54. On the other hand, first hydraulic pump 42 is not operated and does not deliver any hydraulic oil. In this context, during coasting operation of the vehicle, when only second hydraulic pump 44 is pumping, an actual pressure in hydraulic system 57 is adjusted to setpoint value Ps_S (Psetpoint, coasting operation) by transmission control unit 38 or system pressure regulator 52.

Using a check valve 60 assigned to hydraulic pump 42, it is ensured that no hydraulic oil may flow from hydraulic lines 54 back into reservoir 43, counter to the normal delivery direction of first hydraulic pump 42. Consequently, during coasting operation, the required hydraulic pressure is generated in hydraulic lines 54, in transmission control system 34 and in gearing arrangement 28.

For continuously variable transmissions (CVT) or dual-clutch transmissions (DCT), the present invention may be used in specific embodiments similar to FIG. 1. However, this is not illustrated.

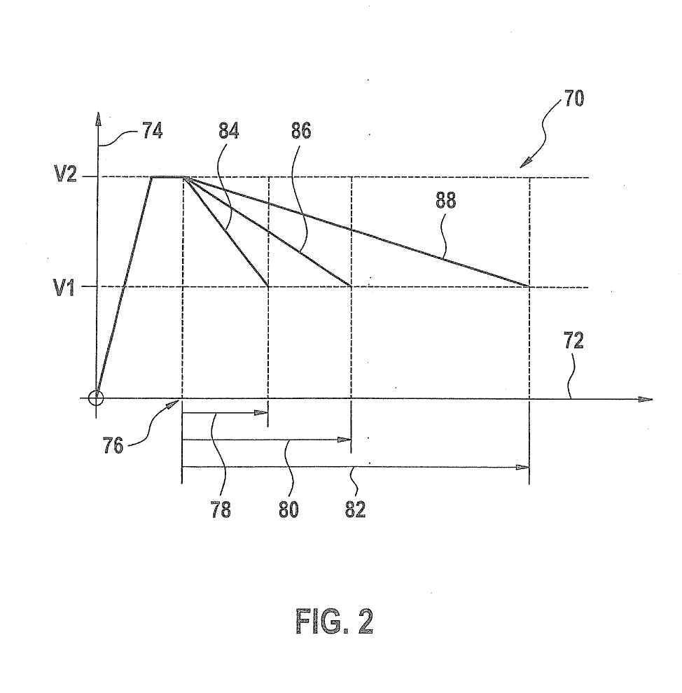

FIG. 2 illustrates a graph for representing different driving states of a motor vehicle. In the present case, it relates to a motor vehicle, which is propelled by a gasoline engine and has a mass of approximately 1,900 kg and an automatic transmission. In a coordinate system 70 illustrated in FIG. 2, a distance 72 is plotted on the abscissa, and a vehicle speed 74 is plotted on the ordinate.

Starting out from an origin shown in the left region of coordinate system 70 of FIG. 2, the vehicle is initially accelerated in a constant manner to a speed V2. Speed V2 is then maintained up to a distance 76. Starting out from distance 76, three different operating states of the vehicle are then shown.

A first curve 84 represents an operating state including an overrun fuel cutoff of internal combustion engine 12, a third gear of the transmission being engaged. A second curve 86 likewise represents an operating state including an overrun fuel cutoff of internal combustion engine 12, a sixth gear of the transmission being engaged. A third curve 88 represents an operating state including a coasting operation of the vehicle, internal combustion engine 12 being switched off and, at the same time, the transmission of power of transmission 10 between input shaft 22 and output shaft 30 being interrupted.

In all three of the above-mentioned operating states, it is apparent that the speed of the vehicle decreases monotonically from speed V2. In the first operating state, a speed V1 reduced in comparison with speed V2 is subsequently reached after covering a rolling distance 78. In the second operating state, speed Vi is reached after covering a rolling distance 80, and in coasting operation, speed V1 is reached after covering a rolling distance 82. In this context, rolling distance 82 is longer than rolling distance 80, and rolling distance 80 is longer than rolling distance 78. In the present case, rolling distance 82 is approximately twice as long as rolling distance 80, and rolling distance 80 is approximately twice as long as rolling distance 78.

Furthermore, it is of significance that in the coasting operation of the vehicle, internal combustion engine 12 is not driven by the vehicle, and consequently, the latter does not absorb any mechanical energy. Accordingly, rolling distance 82 is especially long. In this manner, the fuel consumption of the vehicle is decreased overall and in a comparatively marked manner.

What is claimed is:

1. A transmission of a motor vehicle, comprising:
an input shaft:
an output shaft;
at least one of (i) hydraulically operable actuator, (ii) hydraulic lubrication, and (iii) oil cooling;
a first hydraulic pump driven one of directly or indirectly by the input shaft; and
a second hydraulic pump driven one of directly or indirectly by the output shaft.

2. The transmission as recited in claim 1, wherein the transmission is one of a stepped automatic transmission, a continuously variable transmission, a dual-clutch transmission, or an automated manual transmission.

3. The transmission as recited in claim 2, wherein the first hydraulic pump is driven via a part of a torque converter coupled to the input shaft.

4. The transmission as recited in claim 2, wherein a delivery capacity of at least one of the first and second hydraulic pumps is controlled.

5. The transmission as recited in claim 4, wherein the delivery capacity of the first hydraulic pump is controlled, and the delivery capacity of the second hydraulic pump is not controlled.

6. The transmission as recited in claim 5, wherein a feed pressure of the second hydraulic pump is less than a feed pressure of the first hydraulic pump.

7. The transmission as recited in claim 5, wherein at a given rotational speed, the delivery capacity of the second hydraulic pump is less than the delivery capacity of the first hydraulic pump.

8. The transmission as recited in claim 4, wherein a check valve is provided on a delivery side of at least one of the first and second hydraulic pumps, and wherein the check valve prevents hydraulic oil from flowing back counter to a delivery direction of the hydraulic pumps.

9. The transmission as recited in claim 4, wherein a hydraulic system powered by the first and second hydraulic pumps has at least one pressure sensor for at least one of controlling and diagnosing the transmission.

10. The transmission as recited in claim 9, further comprising:
a hydraulic accumulator which is hydraulically connected to the hydraulic system of the transmission.

11. A method for supplying oil to a motor vehicle transmission having an input shaft; an output shaft; at least one of (i) hydraulically operable actuator, (ii) hydraulic lubrication, and (iii) oil cooling; a first hydraulic pump driven one of directly or indirectly by the input shaft; a second hydraulic pump driven one of directly or indirectly by the output shaft; a hydraulic system powered by the first and second hydraulic pumps; and a pressure control system, the method comprising:
operating the first and second hydraulic pumps such that the delivery capacity of at least one of the first and second hydraulic pumps is controlled; and
adjusting an actual pressure in the hydraulic system to a first setpoint value by the pressure control system, when the first hydraulic pump is pumping.

12. The method as recited in claim 11, wherein the actual pressure in the hydraulic system is adjusted to a second setpoint value by the pressure control system, when only the second hydraulic pump is pumping.

13. The method as recited in claim 12, wherein the first setpoint value is greater than the second setpoint value.

14. The method as recited in claim 13, wherein the pressure in the hydraulic system is adjusted by adjusting the delivery capacity of the first hydraulic pump.

15. The method as recited in claim 13, the pressure in the hydraulic system is adjusted by activating a pressure control valve.

16. A non-transitory computer-readable data storage medium storing a computer program having program codes which, when executed on a computer, performs a method for supplying oil to a motor vehicle transmission having an input shaft; an output shaft; at least one of (i) hydraulically operable actuator, (ii) hydraulic lubrication, and (iii) oil cooling; a first hydraulic pump driven one of directly or indirectly by the input shaft; a second hydraulic pump driven one of directly or indirectly by the output shaft; a hydraulic system powered by the first and second hydraulic pumps; and a pressure control system, the method comprising:
operating the first and second hydraulic pumps such that the delivery capacity of at least one of the first and second hydraulic pumps is controlled; and
adjusting an actual pressure in the hydraulic system to a first setpoint value by the pressure control system, when the first hydraulic pump is pumping.

17. A control device for controlling supply of oil to a motor vehicle transmission having an input shaft; an output shaft;
at least one of (i) hydraulically operable actuator, (ii) hydraulic lubrication, and (iii) oil cooling; a first hydraulic pump driven one of directly or indirectly by the input shaft; a second hydraulic pump driven one of directly or indirectly by the output shaft; a hydraulic system powered by the first and second hydraulic pumps; and a pressure control system, the control device comprising:
means for operating the first and second hydraulic pumps such that the delivery capacity of at least one of the first and second hydraulic pumps is controlled; and
means for adjusting an actual pressure in the hydraulic system to a first setpoint value by the pressure control system, when the first hydraulic pump is pumping.
